(19) United States
(12) Patent Application Publication
(10) Pub. No.: US 2025/0276914 A1
(43) Pub. Date: Sep. 4, 2025

(54) Water Monitoring and Treatment System

(71) Applicant: The United States of America, as represented by the Secretary of the Navy, Arlington, VA (US)

(72) Inventors: Andres Joshua Reyes, San Diego, CA (US); Jeffrey Scott Ellen, San Diego, CA (US); Benjamin Michael Whitmore, Del Mar, CA (US)

(21) Appl. No.: 18/593,044

(22) Filed: Mar. 1, 2024

(51) Int. Cl. C02F 1/00; B63B 79/10; B63J 4/00; C02F 103/00; G06V 10/25; G06V 10/74; G06V 10/764; G06V 20/05; G06V 20/52

(52) U.S. Cl. CPC C02F 1/008; B63B 79/10; B63J 4/002; G06V 10/25; G06V 10/761; G06V 10/764; G06V 20/05; G06V 20/52; C02F 2103/007; C02F 2103/008; C02F 2209/001; C02F 2209/006

(57) ABSTRACT

A water monitoring system comprising a camera mounted to an enclosure so as to capture an underwater image at a given time. An environmental sensor mounted to the enclosure to measure an environmental characteristic of the water at the given time. A reference database containing a library of expertly annotated images of organisms. A processor configured to detect and classify any organisms in the underwater image based on one or more of: (a) the measured environmental characteristic and (b) similarities between a region of interest in the underwater image and one or more of the expertly annotated images. The processor is further configured to activate a mitigator to take steps to decontaminate the water if a target organism is detected. An auditable database configured to store a history of organisms detected and classified by the processor and actions taken by the mitigator as a historical community composition data set.

### FEDERALLY-SPONSORED RESEARCH AND DEVELOPMENT

The United States Government has ownership rights in the invention claimed herein. Licensing and technical inquiries may be directed to the Office of Research and Technical Applications, Naval Information Warfare Center Pacific, Code 72110, San Diego, CA, 92152; voice (619) 553-5118; NIWC_Pacific_T2@us.navy.mil. Reference Navy Case Number 211747.

### BACKGROUND OF THE INVENTION

Water treatment methods to mitigate the spread of invasive species currently exist in the market. However, current methods have drawbacks. For example, current ballast water treatment methods are typically energetically intensive, expensive, or require the vessel to cease operations, resulting in significant time delays and costs. There is a need for an improved method of mitigating the spread of invasive species.

### SUMMARY

Disclosed herein is a water monitoring and treatment system comprising, consisting of, or consisting essentially of an enclosure, a camera, an environmental sensor, a reference database, a processor, a mitigator, and an auditable database. The camera is mounted to the enclosure and positioned so as to capture an underwater image of a known, quantifiable volume of water at a given time. The environmental sensor is mounted to the enclosure and configured to measure an environmental characteristic of the water at the given time. The reference database contains a library of expertly annotated images of organisms. The processor is communicatively coupled to the camera, the reference database, the environmental sensor, the mitigator, and the auditable database. The processor is configured to detect and classify organisms in the underwater image based on one or more of: (a) the measured environmental characteristic at the given time and (b) similarities between a region of interest in the underwater image and one or more of the expertly annotated images. The processor is further configured to activate the mitigator to take steps to decontaminate the water if a target organism is detected. The auditable database is configured to store a history of organisms detected and classified by the processor and actions taken by the mitigator as a historical community composition data set.

Also disclosed herein is a method for treating water comprising the following steps. The first step provides for capturing an underwater image of the water with a camera at a given time. Another step provides for measuring an environmental characteristic of the water near the camera at the given time. Another step provides for using a machine-learning algorithm to detect and classify organisms in the underwater image based on similarities between a region of interest in the underwater image and an expertly annotated image from a reference database of expertly annotated images and also based on the measured environmental characteristic at the given time. Another step provides for initiating appropriate mitigation actions with the processor if a target organism is detected in order to incapacitate the target organism thereby decontaminating the water. Another step provides for storing outputs from the machine-learning algorithm and a record of mitigation actions initiated by the processor as a historical community composition data set in an auditable database.

### BRIEF DESCRIPTION OF THE DRAWINGS

Throughout the several views, like elements are referenced using like references. The elements in the figures are not drawn to scale and some dimensions are exaggerated for clarity.

FIG. 1A is an illustration of a ballast tank embodiment of a water monitoring and treatment system.

FIG. 1B is an illustration of an embodiment of a water monitoring and treatment system mounted on a pier.

FIG. 2 is a flowchart.

FIG. 3 is a flowchart.

FIG. 4A is a side-view illustration of an embodiment of a water treatment system.

FIG. 4B is a side-view illustration of an embodiment of a water treatment system.

### DETAILED DESCRIPTION OF EMBODIMENTS

The disclosed methods and systems below may be described generally, as well as in terms of specific examples and/or specific embodiments. For instances where references are made to detailed examples and/or embodiments, it should be appreciated that any of the underlying principles described are not to be limited to a single embodiment, but may be expanded for use with any of the other methods and systems described herein as will be understood by one of ordinary skill in the art unless otherwise stated specifically.

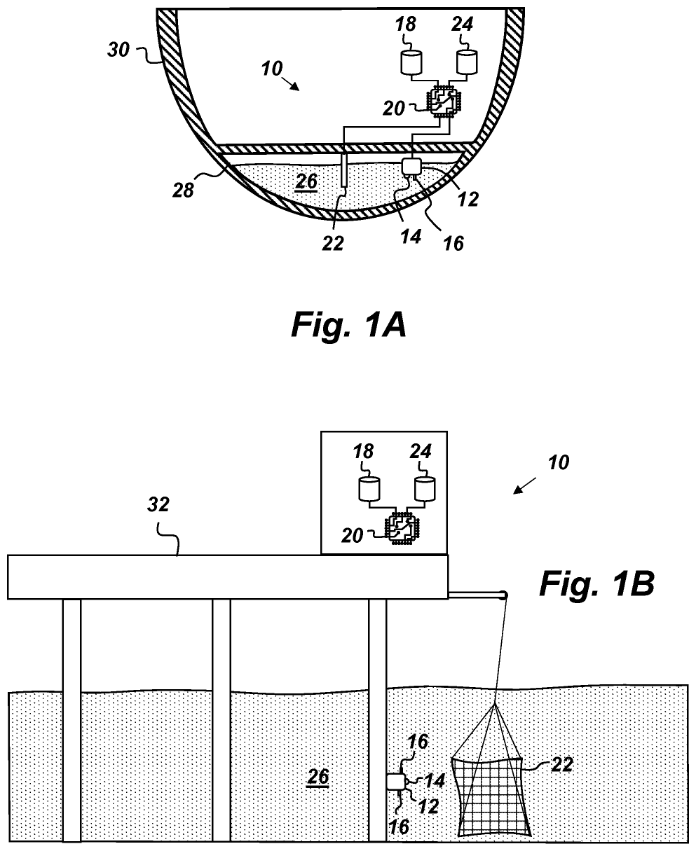

FIG. 1A is an illustration of a ballast tank embodiment of a water monitoring and treatment system 10 (hereinafter referred to as system 10). FIG. 1B is an illustration of a pier-mounted embodiment of system 10. System 10 is a system for determining the biological contents of a sampled volume of water and for enabling action if those contents are undesirable. With respect to ship's ballast tanks, embodiments of system 10 help with mitigation, scientific monitoring, and administrative recordkeeping and auditing by allowing for digital documentation of ballast water organisms in real-time, enabling vessels to document exact times their ballast water is within specifications and the processes that occurred if the water was found to be in non-compliance. System 10 enables monitoring water in situ and engaging in treatment methods only when needed. System 10 may be used to assess whether or not target organisms are present in a given water sample thereby reducing treatment cost by determining whether or not an energy intensive, expensive, or time-consuming water treatment method is required at all at a particular time. System 10 may also be used to determine the efficacy of any such treatment when used. Further, system 10 may be used to create historical documentation of the contents of the water and treatments performed.

System 10 comprises, consists of, or consists essentially of an enclosure 12, a camera 14, an environmental sensor 16, a reference database 18, a processor 20, a mitigator 22, and an auditable database 24. The camera 14 is mounted to the enclosure 12 and positioned so as to capture an underwater image of a known, quantifiable volume of water 26 at a given time. The environmental sensor 16 is mounted to the enclosure 12 and configured to measure an environmental characteristic of the water 26 at the given time. The reference database 18 contains a library of expertly annotated images of organisms. The processor 20 is communicatively coupled to the camera 14, the reference database 18, the environmental sensor 16, the mitigator 22, and the auditable database 24. The processor 20 is configured to detect and classify any organisms (benign and harmful) recorded in the underwater image based on one or more of (a) the measured environmental characteristic at the given time and (b) similarities between a region of interest in the underwater image and one or more of the expertly annotated images. The processor 20 is further configured to activate the mitigator 22 to take steps to decontaminate the water 26 if a target organism is detected. The auditable database 24 is configured to store a history of all organisms detected and classified by the processor 20 and actions taken by the mitigator 22 as a historical community composition data set, which may be used to demonstrate whether or not mitigation actions were successful at degrading a given target organism. Target organisms can include, but are not limited to, invasive species, organisms deemed harmful, microscopic plankton, fish, starfish, urchins, nuisance species, and macroalgae.

In the embodiment of system 10 shown in FIG. 1A, the water 26 is ballast water held in a ballast water tank 28 on a ship 30. However, it is to be understood that system 10 may be used with any desired body of water including, but not limited to, water in a ship's ballast water system, a potable water tank, a water treatment basin, a reservoir, a pool, a lake, a harbor, a marina, a river, and a stream. When the water 26 is a specific, known quantity of water being sampled, the processor 20 may generate quantitative metrics independent of the lens focus of the camera 14, the lighting, whether or not the water is clear or cloudy, etc. In the embodiment of system 10 shown in FIG. 1B, the water 26 is lake water surrounding a pier 32 and the mitigator 22 is a net for physically removing detected target organisms. The mitigator 22 may be any device for removing, destroying, injuring, or incapacitating the target organism(s). Using system 10 in the context of a vessel's ballast water, for example, simultaneously results in increases in vessel transit efficiency and reduced costs, as well as a reduction of the dispersal and the associated adverse effects of aquatic invasive or nuisance species. The camera 14 may be any camera capable of capturing underwater images. For example, in a ballast tank embodiment of system 10 where the target organism is microscopic plankton, the camera 14 may have a resolution of 10 μm per pixel and a sample volume tunnel around 250 mL. Having a known volume of water allows system 10 to compute abundances/densities of the target organism(s) in real time. If the volume of water is not known, system 10 may still be used for detecting and quantifying target organisms within the camera 14's field of view. System 10 is ideally suited for detecting and quantifying target organisms within an enclosed sample volume of water that is visible to the camera and that would otherwise require observation using light, dissecting, or both. Suitable examples of the environmental sensor 16 include, but are not limited to, a temperature sensor, a light meter, an alkalinity sensor, a dissolved oxygen sensor, a pH sensor, a conductivity sensor, an oxidation-reduction potential sensor, a turbidity sensor, an algae sensor, and an ion-selective electrode (ISE). In the embodiment of system 10 shown in FIG. 1A, the processor 20 utilizes the optical images captured by the underwater camera 14 and concurrently sampled environmental metadata from the sensor(s) 16 corresponding to the water 26, which in this example scenario is ballast water inside a ballast water tank, which will provide the baseline information for detection of one or more target organisms.

The reference database 18 may be a library of available images of any desired organisms at different stages of their lifecycles that have preferably been annotated by an expert with respect to one or more of species, life stage, body characteristic, and other visually identifiable characteristics. For example, the reference database 18 may include images of starfish and sea cucumbers when both organisms are at their brachiolaria life stage, and at more mature stages of their lifecycle. It is envisioned that the reference database 18 will include images of mostly, aquatic and marine organisms, but it is not limited to such. Suitable examples of the reference database 18 include, but are not limited to, one or more of the WHOI-Plankton data set (available at https://github.com/hsosik/WHOI-Plankton), the EcoTaxa data set (available at https://ecotaxa.obs-vlfr.fr/explore/), publicly available genomic libraries that exist for proteins such as UniProt, and private databases. Images of organisms stored in the reference database 18 may be used for purposes of digital ground-truthing and validation of a given organism's presence within the water.

The processor 20 may be configured to repeatedly acquire images, optionally apply one or more contrast enhancing algorithms, and then use one or more segmentation or a machine learning algorithm to detect and classify any organisms in the underwater image based on either the image content alone, or optionally a combination of the measured environmental characteristic at the given time and similarities between a region of interest in the underwater image and one of the expertly annotated images. The processor 20 may detect regions of interest within the full frame underwater images and classify them into appropriate categories. The processor 20 may be mounted to the enclosure 12 or positioned at a remote location from the enclosure 12 provided that the processor is still operatively coupled to the camera 14 and the environmental sensor(s) 16. System 10 may have a plurality of environmental sensors 16. In one embodiment of system 10, all of the imaging data from the camera 14 may be consolidated in a computer, of which the processor 20 is part, with the appropriate software to detect and classify target organisms, and to generate a decision tree for treatment of the water.

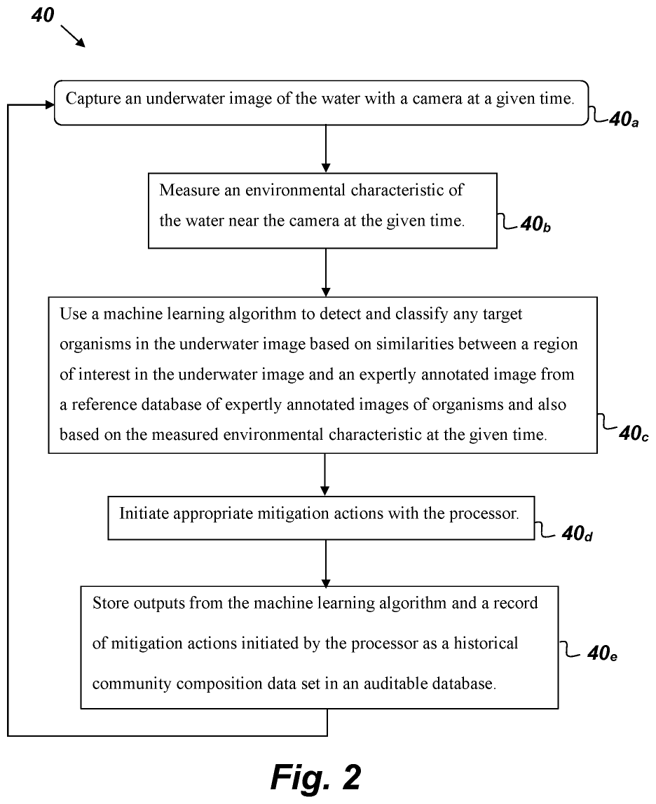

FIG. 2 is a flowchart of a method 40 for monitoring and treating water comprising the following steps. The first step 40ₐ provides for capturing an underwater image of the water with a camera at a given time. Another step 40_{b} provides for measuring an environmental characteristic of the water near the camera at the given time. Another step 40_{c} provides for using a machine-learning algorithm to detect and classify any target organisms in the underwater image based on similarities between a region of interest in the underwater image and an expertly annotated image from a reference database of expertly annotated images and also based on the measured environmental characteristic at the given time. Another step 40_{d} provides for initiating appropriate mitigation actions with the processor. Another step 40ₑ provides for storing outputs from the machine-learning algorithm and a record of mitigation actions initiated by the processor as a historical community composition data set in an auditable database. The steps of method 40 may be repeated to confirm if mitigation actions were successful in degrading the target organism(s).

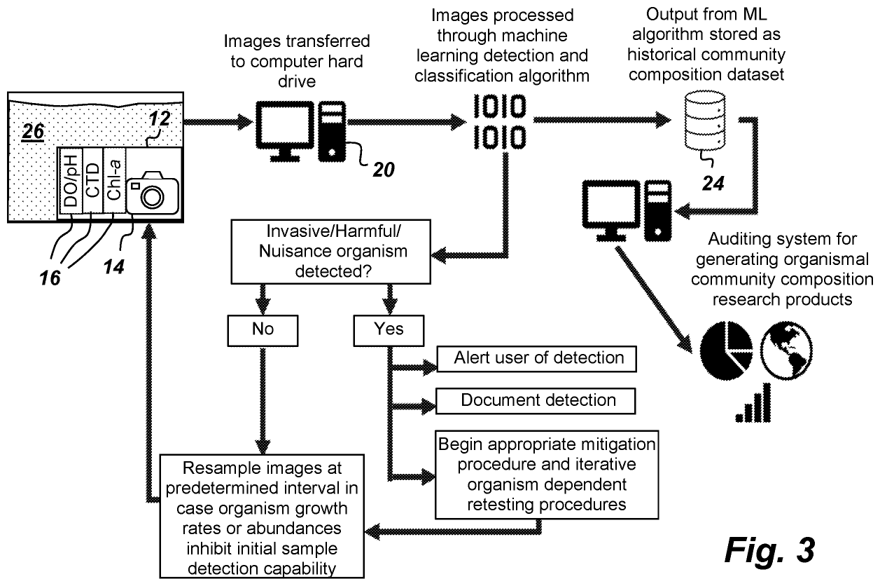

FIG. 3 is a flowchart of another embodiment of a method for monitoring and treating water. In this embodiment, the output of the camera 14 and three environmental sensors 16 (i.e., a dissolved oxygen (DO) and pH sensor, a conductivity, temperature, and depth (CTD) sensor, and a Chlorophyll-a sensor) are transferred to a computer hard drive, such as the processor 20. The environmental sensors 16 and the camera 14 are all immersed in water 26 that is to be monitored and treated. Next, the images and environmental data may be processed through a machine learning detection and classification algorithm such as the algorithm disclosed in the paper “Improving plankton image classification using context metadata” by Ellen, J. S., Graff, C. A. and Ohman, M. D., 2019. Limnology and Oceanography: Methods, 17(8), pp. 439-461, which paper is incorporated by reference herein. The output from the machine-learning algorithm is stored in the auditable database 24 as a historical community composition dataset associated with the particular water being tested/monitored. The contents of the auditable database 24 may then be used by an auditing system to generate organismal community composition research products. If a target organism was detected by the processor 20, a user may be alerted and appropriate mitigation procedures and iterative organism dependent retesting procedures may be initiated. In some embodiments, after being alerted by the system 10, a user may be required to authorize mitigation procedures before they are initiated. Appropriate mitigation procedures may include, but are not limited to, ultraviolet light sterilization, poisoning, increasing the salinity of the water, biological techniques, physical filtering of target organisms from the water, chemical treatment of the water, system flushes, temperature changes, and chemical reactions in which the oxidation states of a reactant change (e.g., redox). In the case where system 10 is used to monitor and treat ballast water held in a ship's ballast tank, the goal of the mitigation is to ensure the target organism(s) (e.g., invasive or nuisance species) is not released in a viable state to a new aquatic environment. The iterative organism-dependent retesting procedures may be conducted according to a desired schedule (e.g., weekly, daily, etc.). Then, after mitigation steps have been taken or no target organisms were detected in the last image, system 10 can be configured to resample images at a predetermined interval in case organism growth rates or abundances inhibit initial sample detection capability.

System 10 and method 40 do not require collecting physical samples and conducting labor intensive microscopy to identify organisms of interest, which can be labor and cost intensive. System 10 and method 40 can determine if mitigation is required; therefore, saving effort, energy, and preventing toxic chemical release when it is not necessary. Further, if mitigation steps are deemed to be required, system 10 and method 40 can determine whether or not a given mitigation was successful, based on which species were present during ballast water inflow, storage, and outflow. System 10 and method 40 are not limited to detecting only phytoplankton (i.e., algae), but may be configured to detect higher level organisms such as, but not limited to, cnidarians, mollusks, mussels, crustaceans, echinoderms, and fish. In some embodiments of system 10 and method 40, environmental DNA (eDNA) may be used to identify if organisms of interest are present or absent in the water under test. For example, if two organisms are too similar to be differentiated by the optical images captured by the camera 14, an eDNA test may be used as a deciding factor as to whether or not a target organism is present in the water 26. If a target organism (e.g., crown of thorns starfish larvae) is present then mitigation procedures can be initiated. If not, mitigation steps do not have to be initiated.

Some embodiments of system 10 may be used and installed in-line with a ship's ballast water plumbing. In other embodiments of the system 10 and method 40, the enclosure 12 may be dropped or cast into a ballast tank, mounted to a wall of, or otherwise within, the ballast tank, or used on remote sensing instruments used to collect oceanographic data. Embodiments of method 40 may be implemented digital, as opposed to chemical sampling or human microscopy. Embodiments of system 10 may be a networked, central monitoring system for ships' ballast water, where the data from each ship equipped with system 10 is shared in order to improve the accuracy of the machine-learning algorithm as well as notice trends over time and detect correlations between methods of transport.

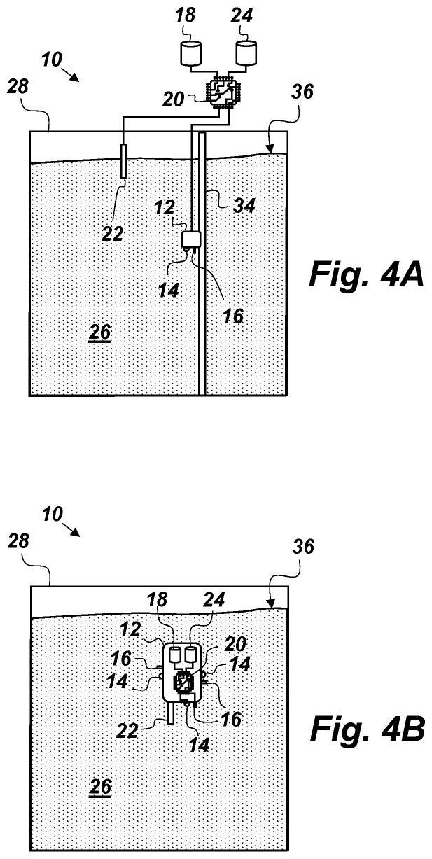

FIG. 4A is a side-view illustration of an embodiment of system 10 in ballast tank 28, where the enclosure 12 is configured to move vertically along a track 34 within the water 26 so as to be able to profile the water 26 at the bottom of the tank 28 and back to the surface 36. System 10 can be configured to move vertically in the water 26 by hand. For example, the enclosure 12 may be configured to be lowered into the water by a line paid out by hand or mechanically.

FIG. 4B is a side-view illustration of a self-contained embodiment of system 10 where the processor 20 and the reference database 16 and the auditable database 24 are all contained within the enclosure 12, which may be immersed in the water 26. The system 10 may be configured to move itself about within the water 26 with one or more of water or air jets, propellers, internal ballast tanks, or other means such as are known in the art. This self-contained embodiment of system 10 may be retrieved from the water 26 after a period of time to audit the auditable database 24. The enclosure 12 may be made to be neutrally buoyant within the water 26 or positively buoyant so as to enable it to float on the surface 36. Embodiments of the system 10 may be configured to passively capture the underwater images and measure environmental characteristics without agitating the water 26. In some embodiments, system 10 may be fully self-contained, battery operated, and compact as possible. Such embodiments may be desirable when the system 10 is deployed in a ballast water tank (where there is a desire to not damage the integrity of the tank by running any cables/wires through a wall thereof) or in a remote/sensitive/high traffic habitat where it would be desirable for the system 10 to be self-contained with no surface expression to avoid being in the way of ships.

Returning to the discussion of method 40, steps 40ₐ through 40ₑ may be performed independently by multiple vessels. Then, the historical community composition data sets from the multiple vessels may be compiled to build a model of invasive species propagation including time and location that identifies windows of susceptibility. Automatic identification system (AIS) tracks stored, displayed, or both stored and displayed in a maritime situational awareness tool may be examined to identify any vessel having a corresponding AIS track that passed through the window of susceptibility so as to identify potentially-infected vessels.

From the above description of system 10 and method 40, it is manifest that various techniques may be used for implementing the concepts of system 10 and method 40 without departing from the scope of the claims. The described embodiments are to be considered in all respects as illustrative and not restrictive. The method/apparatus disclosed herein may be practiced in the absence of any element that is not specifically claimed and/or disclosed herein. It should also be understood that system 10 and method 40 are not limited to the particular embodiments described herein, but is capable of many embodiments without departing from the scope of the claims.

We claim:

1. A water monitoring and treatment system comprising:
an enclosure;
a camera mounted to the enclosure and positioned so as to capture an underwater image of a known, quantifiable volume of water at a given time;
an environmental sensor mounted to the enclosure and configured to measure an environmental characteristic of the water at the given time;
a reference database of expertly annotated images of organisms;
a processor communicatively coupled to the camera, the reference database, and the environmental sensor, wherein the processor is configured to detect and classify any organisms in the underwater image based on one or more of (a) the measured environmental characteristic at the given time and (b) similarities between a region of interest in the underwater image and one or more of the expertly annotated images;
a mitigator communicatively coupled to the processor, wherein the processor is further configured to activate the mitigator to take steps to decontaminate the water if a target organism is detected; and
an auditable database communicatively coupled to the processor wherein the auditable database is configured to store a history of organisms detected and classified by the processor and actions taken by the mitigator as a historical community composition data set.

2. The system of claim 1, wherein the enclosure is configured to move vertically within the water so as to create a profile of the water.

3. The system of claim 1, wherein the enclosure is configured to float on the water.

4. The system of claim 1, wherein the known, quantifiable volume of water is ballast water within a ballast tank.

5. The system of claim 4, further comprising an environmental DNA (eDNA) tester communicatively coupled to the processor, which is further configured to detect and classify organisms based on an output of the eDNA tester.

6. The system of claim 4, further comprising a plurality of additional environmental sensors, each of which being configured to measure a separate environmental characteristic of the ballast water at the given time, wherein the processor is further configured to use a machine learning algorithm to detect and classify the organisms.

7. The system of claim 1, wherein the camera and the environmental sensor are configured to passively capture underwater images and measure environmental characteristics without agitating the water.

8. A method for treating water comprising:
capturing an underwater image of the water with a camera at a given time;
measuring an environmental characteristic of the water near the camera at the given time;
using a machine learning algorithm to detect and classify organisms in the underwater image based on similarities between a region of interest in the underwater image and an expertly annotated image from a reference database of expertly annotated images and also based on the measured environmental characteristic at the given time;
if a target organism is detected in the water, initiating, with the processor, mitigation actions understood to be effective in incapacitating the target organism with an aim of decontaminating the water; and
storing outputs from the machine learning algorithm and a record of mitigation actions initiated by the processor as a historical community composition data set in an auditable database.

9. The method of claim 8, wherein the steps of capturing and measuring are performed both before and after the mitigation actions.

10. The method of claim 9, wherein if a target organism is not detected in the water, further comprising repeating the steps of claim 8 according to a predetermined schedule.

11. The method of claim 10, further comprising alerting a user if a target organism is detected in the water.

12. The method of claim 11, wherein the water is ballast water held in a vessel's ballast water tank, and further comprising using the historical community composition data set to establish whether or not the ballast water poses a threat to another body of water.

13. The method of claim 12, further comprising auditing the vessel's port-worthiness for a given port by examining the historical community composition data set.

14. The method of claim 13, further comprising conditioning the vessel's entry into the given port based on a clean audit of the vessel's historical community composition data set.

15. The method of claim 8, wherein no mitigation actions are taken unless a target organism is detected in the water.

16. The method of claim 13, further comprising identifying a probable source of a given target organism based on the vessel's historical community composition data set and the vessel's travel history.

17. The method of claim 16, further comprising:
performing the steps of claim 12 with respect to multiple vessels; and
compiling historical community composition data sets from the multiple vessels to build a model of invasive species propagation including time and location that identifies windows of susceptibility.

18. The method of claim 17, further comprising comparing all AIS tracks in a maritime situational awareness tool to identify any vessel having a corresponding AIS track that passed through the window of susceptibility so as to identify potentially-infected vessels.

19. The method of claim 8, wherein no chemical sampling or human microscopy is involved in creating a given vessel's historical community composition data set.

20. The method of claim 11 further comprising using environmental DNA after mitigation actions have been taken to determine if the target organism is still present in the ballast water.
